(19) United States
(12) Patent Application Publication
(10) Pub. No.: US 2010/0104211 A1
(43) Pub. Date: Apr. 29, 2010

(54) Image processing apparatus, image processing method, and computer program

(75) Inventors: Yoichi Hirota, Kanagawa (JP); Kiyoshi Ikeda, Kanagawa (JP); Masashi Ota, Tokyo (JP); Toshimichi Hamada, Tokyo (JP); Hiromasa Naganuma, Chiba (JP); Makoto Tsukamoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/587,715

(22) Filed: Oct. 13, 2009

(30) Foreign Application Priority Data
Oct. 24, 2008 (JP) P2008-274166

(51) Int. Cl. G06K 9/40

(52) U.S. Cl. 382/260

(57) ABSTRACT

An image processing apparatus includes: ΔΣ modulation means for applying ΔΣ modulation to an image; analog conversion means for converting a signal of the image, whose gradation is converted by the ΔΣ modulation means, into an analog signal; digital output means for outputting a digital signal of the image after gradation conversion; and analog output means for outputting an analog signal of the image after gradation conversion. The ΔΣ modulation means includes arithmetic means for filtering a quantization error; adding means for adding a pixel value of the image and output of the arithmetic means; quantization means for quantizing output of the adding means and outputting a quantized value; and subtracting means for calculating a difference between the output of the adding means and the quantized value. A filter coefficient for the filtering corresponding to the analog output is determined according to a frequency characteristic of the analog conversion means.

### CROSS-REFERENCE TO RELATED APPLICATION

The present application claims priority from Japanese Patent Application No. JP 2008-274166 filed in the Japanese Patent Office on Oct. 24, 2008, the entire content of which is incorporated herein by reference.

### BACKGROUND OF THE INVENTION

1. Field of the Invention

The present invention relates to an image processing apparatus, an image processing method, and a computer program, and, more particularly to an image processing apparatus, an image processing method, and a computer program for making it possible to perform gradation conversion for improving an image quality in appearance even when an image signal is converted via a DA converter.

2. Description of the Related Art

For example, when an image having an N-bit pixel value (hereinafter also referred to as N-bit image) is displayed with a display device that displays an image having an M-bit pixel value smaller than N bits, the N-bit image needs to be converted into an M-bit image. In other words, it is necessary to perform gradation conversion for converting the gradation of an image.

As a method of gradation-converting the N-bit image into the M-bit image (a gradation converting method), for example, there is a method of truncating lower-order N−M bits of the N-bit pixel value to converts the N-bit pixel value into the M-bit pixel value. When N is 8 and M is 4, there is a method of gradation-converting, an 8-bit image in a gray scale into a 4-bit image by truncating lower-order 4 bits.

However, although 256 (=2⁸) gradations can be represented by 8 bits, only 16 (=2⁴) gradations can be represented by 4 bits. Therefore, in the gradation conversion for truncating lower-order 4 bits of the 8-bit image, banding in which a change in gradation looks like a band occurs.

As a gradation converting method for preventing such banding from occurring and simulatively representing, in an image after gradation conversion, the gradation of an image before the gradation conversion, there is a method called error diffusion method.

The error diffusion method is a method of performing image ΔΣ modulation for modulating a quantization error, which occurs when the N-bit image is gradation-converted into the M-bit image, into a high-frequency band taking into account a human visual characteristic. In the error diffusion method, a two-dimensional filter that filters the quantization error is used. As the two-dimensional filter, a filter of Jarvis, Judice & Ninke (hereinafter referred to as Jarvis filter) and a filter of Floyd & Steinberg (hereinafter referred to as Floyd filter) are known (see, for example, Hitoshi Takaie, “Yokuwakaru Digital Image Processing”, sixth edition, CQ publishing Co., Ltd. January 2000, p. 196 to 213).

Gradation conversion processing by the error diffusion method can be applied to a recording and reproducing apparatus that reproduces an image from a disk such as a Blu-Ray® disk that can record a 12-bit image. Specifically, for example, when the recording and reproducing apparatus outputs the 12-bit image read out from the Blu-Ray® disk to a display that displays an 8-bit image, the recording and reproducing apparatus can perform the gradation conversion processing.

As such a recording and reproducing apparatus, in recent years, there are an increasing number of recording and reproducing apparatuses that output image signals as digital signals on the basis of standards such as HDMI® (High-Definition Multimedia Interface) and DVI (Digital Visual Interface).

However, there are still a large number of reception side apparatuses that receive only image signals as analog signals. In general, the recording and reproducing apparatuses also include analog output terminals that output image signals as analog signals such as a component terminal and a D terminal.

### SUMMARY OF THE INVENTION

To output an image signal from an analog output terminal, it is necessary to convert a digital image signal read out from a disk into an analog signal using a DA converter (DA conversion).

The DA converter has a characteristic of deteriorating a signal of a high-frequency component as a frequency characteristic. Therefore, when an image signal after an image including a large number of bits is converted into an image including a small number of bits by modulating the signal into a high frequency band with the gradation conversion processing by the error diffusion method as explained above is subjected to the DA conversion, a high-frequency component generated by the gradation conversion processing is lost. In other words, the effect of the gradation conversion processing by the error diffusion method is reduced.

Therefore, it is desirable to make it possible to perform gradation conversion for improving an image quality in appearance even when an image signal is converted via a DA converter.

According to an embodiment of the present invention, there is provided an image processing apparatus including: ΔΣ modulation means for applying ΔΣ modulation to an image to thereby convert the gradation of the image; analog conversion means for converting a signal of the image, the gradation of which is converted by the ΔΣ modulation means, into an analog signal; digital output means for outputting a digital signal of the image after gradation conversion; and analog output means for outputting an analog signal of the image after gradation conversion. The ΔΣ modulation means includes: arithmetic means for filtering a quantization error; adding means for adding up a pixel value of the image and output of the arithmetic means; quantization means for quantizing output of the adding means and outputting a quantized value including the quantization error as a result of the ΔΣ modulation; and subtracting means for calculating a difference between the output of the adding means and the quantized value of the output of the adding means to thereby calculate the quantization error. A filter coefficient for the filtering by the arithmetic means corresponding to the analog output is determined according to a frequency characteristic of the analog conversion means.

According to another embodiment of the present invention, there is provided an image processing method for an image processing apparatus including: ΔΣ modulation means for applying ΔΣ modulation to an image to thereby convert the gradation of the image; analog conversion means for converting a signal of the image, the gradation of which is converted by the ΔΣ modulation means, into an analog signal; digital output means for outputting a digital signal of the image after gradation conversion; and analog output means for outputting an analog signal of the image after gradation conversion. The ΔΣ modulation means includes: arithmetic means for filtering a quantization error; adding means for adding up a pixel value of the image and output of the arithmetic means; quantization means for quantizing output of the adding means and outputting a quantized value including the quantization error as a result of the ΔΣ modulation; and subtracting means for calculating a difference between the output of the adding means and the quantized value of the output of the adding means to thereby calculate the quantization error. The image processing method includes the steps of: the adding means adding up the pixel value of the image and the output of the arithmetic means; the quantization means quantizing the output of the adding means and outputting the quantized value including the quantization error as the result of the ΔΣ modulation; the subtracting means calculating the difference between the output of the adding means and the quantized value of the output of the adding means to thereby calculate the quantization error; and the arithmetic means filtering the quantization error and outputting a result of the filtering to the adding means. A filter coefficient for the filtering by the arithmetic means corresponding to the analog output is determined according to a frequency characteristic of the analog conversion means.

According to still another embodiment of the present invention, there is provided a computer program for causing a computer to function as: ΔΣ modulation means for applying ΔΣ modulation to an image to thereby convert the gradation of the image; and analog conversion means for converting a signal of the image, the gradation of which is converted by the ΔΣ modulation means, into an analog signal. The ΔΣ modulation means includes: arithmetic means for filtering a quantization error; adding means for adding up a pixel value of the image and output of the arithmetic means; quantization means for quantizing output of the adding means and outputting a quantized value including the quantization error as a result of the ΔΣ modulation; and subtracting means for calculating a difference between the output of the adding means and the quantized value of the output of the adding means to thereby calculate the quantization error. A filter coefficient for the filtering by the arithmetic means corresponding to the analog output is determined according to a frequency characteristic of the analog conversion means.

According to the embodiments of the present invention, the adding means adds up the pixel value of the image and the output of the arithmetic means, the quantization means quantizes the output of the adding means and outputs the quantized value including the quantization error as the result of the ΔΣ modulation, the subtracting means calculates the difference between the output of the adding means and the quantized value of the output of the adding means to thereby calculate the quantization error, and the arithmetic means filters the quantization error and outputs a result of the filtering to the adding means. The filtering coefficient for the filtering by the arithmetic means corresponding to the analog output is determined according to the frequency characteristic of the analog conversion means.

The image processing apparatus may be an independent apparatus or may be an internal block included in one apparatus.

It is possible to provide the computer program by transmitting the computer program via a transmission medium or recording the computer program on a recording medium.

According to the embodiments of the present invention, it is possible to perform gradation conversion for improving an image quality in appearance even when an image signal is converted via a DA converter.

### BRIEF DESCRIPTION OF THE DRAWINGS

FIG. 1 is a block diagram of a configuration example of a recording and reproducing apparatus according to an embodiment of the present invention;

FIG. 2 is a block diagram of a configuration example of an image processing unit;

FIG. 3 is a block diagram of a detailed configuration example of a gradation converting unit;

FIG. 4 is a diagram for explaining order of pixels to be subjected to gradation conversion processing;

FIG. 5 is a diagram of pixels including quantization errors used for calculation of a feedback value;

FIG. 6 is a diagram of a configuration example of a two-dimensional filter;

FIG. 7 is a diagram for explaining cycle/degree as a unit of a spatial frequency;

FIG. 8 is a graph of a human vision characteristic and an amplitude characteristic of noise shaping of the gradation converting unit;

FIG. 9 is a flowchart for explaining gradation conversion output processing by a digital signal;

FIG. 10 is a graph of a frequency characteristic of a DA converter;

FIG. 11 is a graph of an amplitude characteristic of noise shaping by the gradation converting unit;

FIG. 12 is a graph of the frequency characteristic of the DA converter and the amplitude characteristic of the noise shaping by the gradation converting unit;

FIG. 13 is a block diagram of a detailed configuration example of the gradation converting unit;

FIG. 14 is a diagram of a configuration example of a two-dimensional filter;

FIG. 15 is a flowchart for explaining gradation conversion output processing by an analog signal;

FIG. 16 is a block diagram of another configuration example of the image processing unit; and

FIG. 17 is a block diagram of a detailed configuration example of the gradation converting unit.

### DESCRIPTION OF THE PREFERRED EMBODIMENTS

### A Configuration of a Recording and Reproducing Apparatus

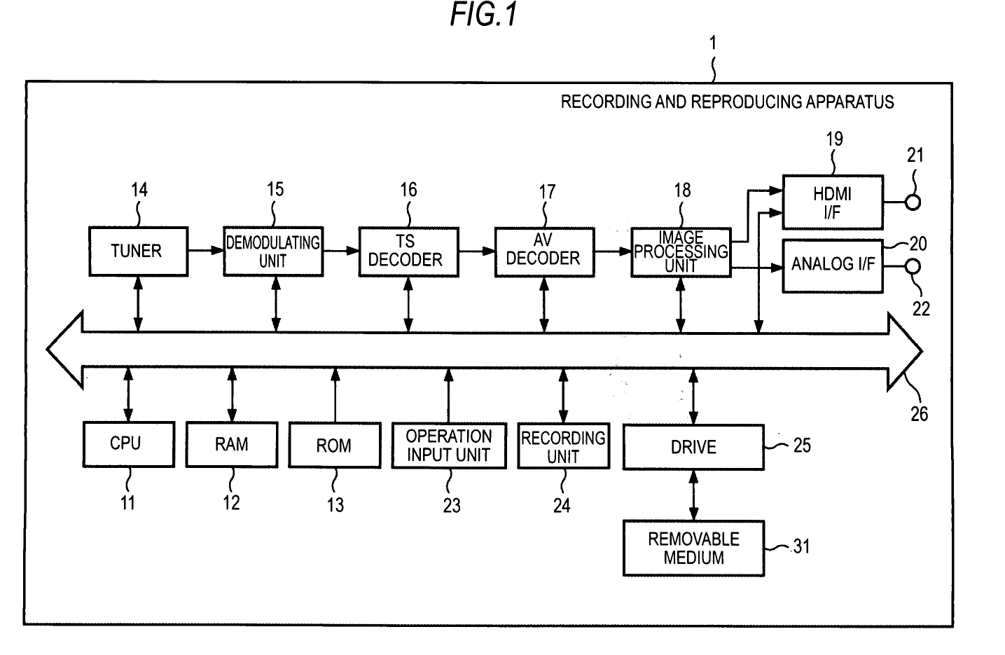

FIG. 1 is a block diagram of a recording and reproducing apparatus according to an embodiment of the present invention.

A recording and reproducing apparatus 1 shown in FIG. 1 includes a CPU (Central Processing Unit) 11, a RAM (Random Access Memory) 12, a ROM (Read Only Memory) 13, a tuner 14, a demodulating unit 15, a TS decoder 16, an AV decoder 17, an image processing unit 18, a HDMI I/F 19, an analog I/F 20, an HDMI output terminal 21, and an analog output terminal 22.

The recording and reproducing apparatus 1 also includes an operation input unit 23, a recording unit 24, and a drive 25. The CPU 11, the RAM 12, the ROM 13, the TS decoder 16, the AV decoder 17, the image processing unit 18, the HDMI I/F 19, the operation input unit 23, the recording unit 24, and the drive 25 are connected to one another via a bus 26.

The CPU 11 executes various kinds of processing according to a computer program stored in the ROM 13 or a computer program loaded from the recording unit 24 to the RAM 12. The CPU 11 receives, via the bus 26, an instruction for processing and data input by a user on the operation input unit 23 and controls the tuner 14, the image processing unit 18, and the like on the basis of the input instruction for processing and the like. Examples of the processing instructed by the user include recording or reproduction processing for contents received by the tuner 14.

The RAM 12 stores computer programs used in the execution by the CPU 11 and parameters and data that change as appropriate in the execution.

The ROM 13 stores basically stationary data among the computer programs used by the CPU 11 and the parameters for arithmetic operation.

The tuner 14 receives a broadcast signal from a not-shown antenna under the control by the CPU 11 and supplies a reception signal obtained as a result of the reception to the demodulating unit 15.

The demodulating unit 15 demodulates the reception signal supplied from the tuner 14 and supplies a transport stream in a predetermined channel to the TS decoder 16.

The TS decoder 16 extracts a predetermined stream from the transport stream supplied from the demodulating unit 15 and supplies a packet included in the extracted stream to the AV decoder 17 under the control by the CPU 11. The TS decoder 16 can also supply the packet to the recording unit 24 via the bus 26 or supply the packet to the drive 25 and cause the drive 25 to store the packet on a removable medium 31.

The AV decoder 17 decodes video data supplied from the TS decoder 16 as the packet and supplies image data obtained as a result of the decoding to the image processing unit 18. The AV decoder 17 decodes video data read out from the recording unit 24 via the bus 26 and supplies image data obtained as a result of the decoding to the image processing unit 18. Video data read out from the removable medium 31 by the drive 25 can be processed in the same manner.

Besides the video data, audio data is also supplied from the TS decoder 16 as a packet. However, explanation of the audio data is omitted.

The image processing unit 18 includes a processor such as a CPU or a DSP (Digital Signal Processor). The image processing unit 18 performs gradation conversion processing for gradation-converting an N-bit image supplied from the AV decoder 17 into an M-bit image. The image processing unit 18 can apply, according to necessity, other processing such as noise reduction to the image data supplied from the AV decoder 17.

The image processing unit 18 supplies a digital signal of an image (an image signal) after gradation conversion to the HDMI I/F 19. The image processing unit 18 supplies an analog image signal obtained by DA-converting the digital signal of the image (the image signal) after the gradation conversion to the analog I/F 20.

The HDMI I/F 19 converts the video data from the image processing unit 18 into a format of HDMI® and outputs a HDMI signal obtained as a result of the conversion to the HDMI output terminal 21. The HDMI I/F 19 acquires information concerning EDID (Extended display identification data) and CEC (Consumer Electronics Control) (hereinafter collectively referred to as HDMI control information) from a display (not shown in the figure) connected via the HDMI output terminal 21 and supplies the HDMI control information to the CPU 11 via the bus 26.

The HDMI output terminal 21 outputs the digital image signal after the gradation conversion as the HDMI signal supplied from the image processing unit 18 via the HDMI I/F 19.

The analog I/F 20 converts the analog image signal supplied from the image processing unit 18 into a predetermined image signal such as a component signal and outputs the image signal to the analog output terminal 22. The analog output terminal 22 outputs the analog image signal after the gradation conversion supplied from the image processing unit 18 via the analog I/F 20.

The operation input unit 23 includes buttons, switches, a keyboard, or a mouse. The operation input unit 23 is operated by the user when the user inputs various commands to the recording and reproducing apparatus 1.

The recording unit 24 includes a hard disk and records the computer programs executed by the CPU 11 or the video data (and the audio data) supplied from the TS decoder 16 via the bus 26.

The removable medium 31 including a magnetic disk, an optical disk, a magneto-optical disk, or a semiconductor memory is inserted in the drive 25 as appropriate. The drive causes the removable medium 31 to record the video data supplied from the TS decoder 16. The drive 25 reproduces the video data recorded in the removable medium 31 and supplies the video data to the TS decoder 16 via the bus 26.

The recording and reproducing apparatus 1 configured as explained above can cause a display connected via the HDMI output terminal 21 or the analog output terminal 22 to display an image having predetermined content obtained from a broadcast signal. The recording and reproducing apparatus 1 can cause the display connected via the HDMI output terminal 21 or the analog output terminal 22 to display an image having predetermined content read out from the recording unit 24 or the removable medium 31.

According to the HDMI control information acquired via the HDMI I/F 19, it is assumed that the number of bits of an image that the connected display can display is, for example, 8 bits and the number of bits of an image supplied from the AV decoder 17 is 12 bits. In this case, the image processing unit 18 of the recording and reproducing apparatus supplies a digital image signal obtained by gradation-converting the 12-bit image into the 8-bit image to the HDMI I/F 19.

Concerning an analog signal, the image processing unit 18 can supply an analog image signal obtained by gradation-converting the 12-bit image into the 8-bit image to the analog I/F 20.

### A First Configuration Example of the Image Processing Unit 18

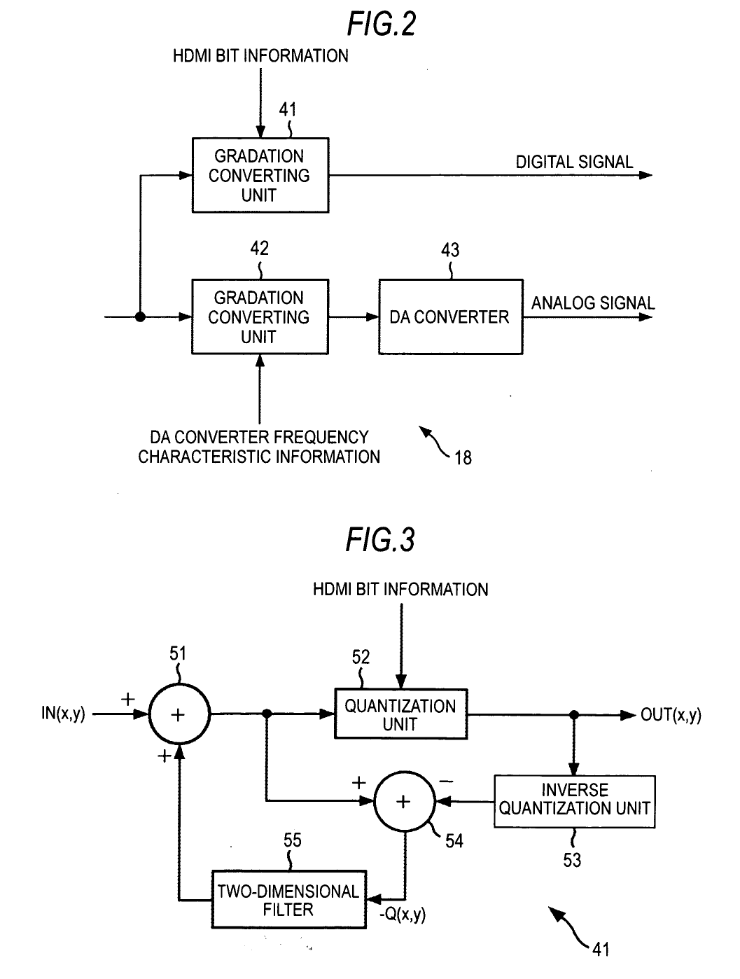

FIG. 2 is a block diagram of a configuration example of the image processing unit 18 that performs gradation conversion.

The image processing unit 18 includes a gradation converting unit 41, a gradation converting unit 42, and a DA converter 43. The image processing unit 18 performs gradation conversion (processing) by the error diffusion method. In this embodiment, for example, the 12-bit image is gradation-converted into the 8-bit image.

(Data of) the 12-bit image is supplied to the gradation converting units 41 and 42.

The number of bits (8 bits) of the image that the display connected via the HDMI I/F 19 can display is supplied to the gradation converting unit 41 from the CPU 11 as HDMI bit information.

On the other hand, information representing a frequency characteristic of the DA converter 43 (hereinafter referred to as DA converter frequency characteristic information) is supplied to the gradation converting unit 42 from the CPU 11.

Both the gradation converting units 41 and 42 gradation-convert the 12-bit image supplied from the AV decoder 17 into the 8-bit image. The gradation converting unit 41 performs gradation conversion processing for digital output. The gradation converting unit 42 performs gradation conversion processing for analog output. The gradation conversion processing executed by the gradation converting units 41 and 42 is gradation conversion processing by the error diffusion method for modulating, taking into account the human vision characteristic, a quantization error that occurs in the gradation conversion into a high-frequency band. However, bands into which the quantization error that occurs in the gradation conversion is modulated are different in the gradation converting units 41 and 42. Whereas the gradation converting unit 41 modulates the quantization error into a predetermined high-frequency band, the gradation converting unit 42 modulates the quantization error into a band corresponding to the DA converter frequency characteristic information, which is a band slightly lower than the band of the gradation converting unit 41. The bands into which the quantization error is modulated by the gradation converting units 41 and 42 are explained later with reference to FIG. 11 and the like.

The gradation converting unit 41 outputs an 8-bit digital image signal after the gradation conversion to the HDMI I/F 19. Also, the gradation converting unit 42 outputs the 8-bit digital image signal after the gradation conversion to the DA converter 43.

The DA converter 43 converts the 8-bit digital image signal after the gradation conversion from the gradation converting unit 42 into an analog signal and outputs the analog signal to the analog I/F 20.

### [A Configuration of the Gradation Converting Unit 41]

FIG. 3 is a block diagram of a detailed configuration example of the gradation converting unit 41.

The gradation converting unit 41 includes an arithmetic unit 51, a quantization unit 52, an inverse quantization unit 53, an arithmetic unit 54, and a two-dimensional filter 55.

Pixel values IN(x,y) of pixels (x,y) of the 12-bit image are supplied to the arithmetic unit 51 in raster scan order as a target image of the gradation conversion (a conversion target image). Output of the two-dimensional filter 55 is also supplied to the arithmetic unit 51.

The arithmetic unit 51 adds up the pixel values IN(x,y) and the output of the two-dimensional filter 55 and supplies an added-up value obtained as a result of the addition to the quantization unit 52 and the arithmetic unit 54.

The quantization unit 52 quantizes the added-up value supplied from the arithmetic unit 51 into 8 bits represented by the HDMI bit information. For example, an 8-bit quantized value is generated by truncating LSB (Least Significant Bit) 4 bits from the 12-bit pixel values IN(x,y). The quantized value obtained as a result of the quantization is output as pixel values OUT(x,y) of the pixels (x,y) after the gradation conversion and supplied to the inverse quantization unit 53.

The inverse quantization unit 53 inversely quantizes the 8-bit image supplied from the quantization unit 52 into the 12-bit image and supplies an inversely-quantized value obtained as a result of the inverse quantization to the arithmetic unit 54. For example, the inverse quantization unit 53 pads (adds) 0 to LSB 4 bits of the 8-bit pixel values OUT(x,y) to thereby generate the 12-bit inversely-quantized value.

The arithmetic unit 54 subtracts the pixel values OUT(x,y) after the inverse quantization, which are supplied from the inverse quantization unit 53, from the added-up value supplied from the arithmetic unit 51 to calculate quantization errors −Q(x,y) caused by the quantization in the quantization unit 52 and supplies the quantization errors −Q(x,y) to the two-dimensional filter 55. In other words, the arithmetic unit 54 subtracts the output from the quantization unit 52 from the input to the quantization unit 52 to calculate the quantization errors −Q(x,y) caused by the quantization in the quantization unit 52.

The two-dimensional filter 55 is a two-dimensional filter that filters a signal. The two-dimensional filter 55 filters the quantization errors −Q(x,y) supplied from the arithmetic unit 54 and outputs a result of the filtering to the arithmetic unit 51.

The arithmetic unit 51 adds up the result of the filtering of the quantization errors −Q(x,y) output by the two-dimensional filter 55 as explained above and the pixel values IN (x,y).

Therefore, in the gradation converting unit 41, the quantization errors −Q(x,y) are fed back to the input side (the arithmetic unit 51) via the two-dimensional filter 55 to configure a two-dimensional ΔΣ modulator.

With the two-dimensional ΔΣ modulator explained above, for example, when a person looks at an image having 256 gradations obtained by gradation-converting an image having 4096 gradations, in the image, 4096 gradations can be represented by 256 gradations and an image having a satisfactory image quality can be obtained.

### [Processing Order of the Gradation Conversion]

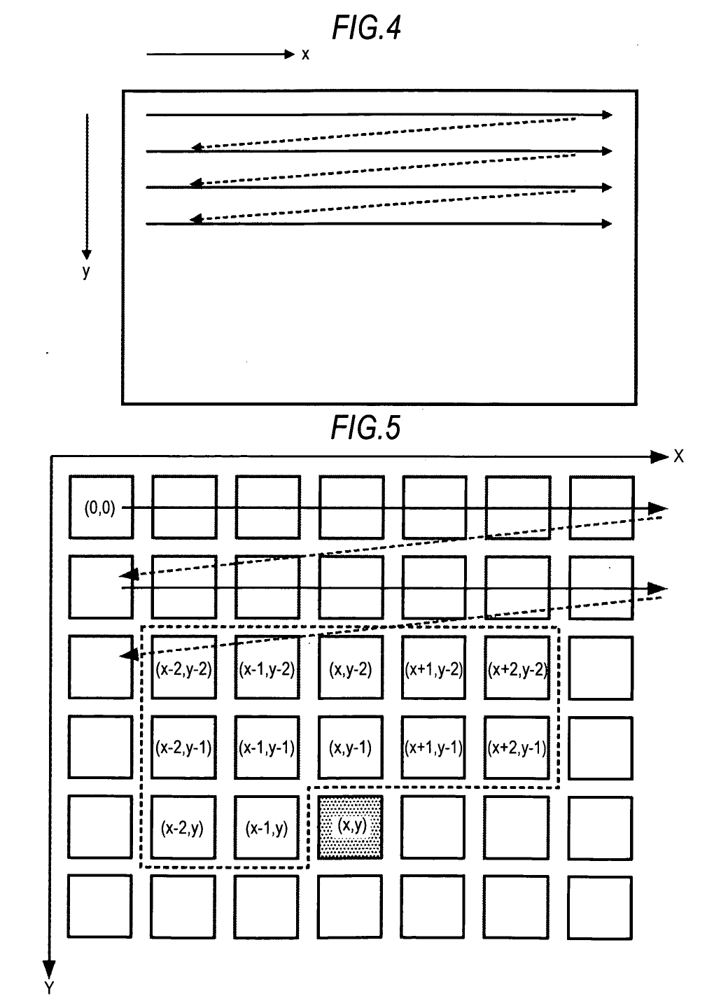

FIG. 4 is a diagram of order of pixels to be subjected to the gradation conversion processing by the gradation converting unit 41.

As explained above, the pixel values IN(x,y) of the pixels (x,y) of the conversion target image are supplied to the gradation converting unit 41 in the raster scan order shown in FIG. 4. Therefore, in the gradation converting unit 41, the pixel values IN(x,y) of the pixels (x,y) of the conversion target image are set as a target of the gradation conversion processing in raster scan order.

### [Pixels Including Quantization Errors Used in Calculation of a Feedback Value]

FIG. 5 is a diagram of pixels including quantization errors used in calculation of a feedback value of the pixels (x,y).

In FIG. 5, positions (coordinates) of pixels of a conversion target image are represented by a two-dimensional coordinate system with (the center of) a pixel on the upper left set as a reference coordinate (the origin) (0, 0), the abscissa set as an x axis, and the ordinate set as a y axis. It is assumed that a distance between pixels adjacent to each other is 1.

When a feedback value for the pixel values IN(x,y) is calculated in the two-dimensional filter 55, quantization errors in the past are used. Specifically, an area surrounded by a dotted line in FIG. 5 indicates an area of quantization errors in the past used for calculating a feedback value for the pixel values IN(x,y) (a quantization error use area). Quantization errors included in the quantization error use area of the pixels (x,y) are −Q(x−2,y−2), −Q(x−1,y−2), −Q(x,y−2), −Q(x+1,y−2), −Q(x+2,y−2), −Q(x−2,y−1), −Q(x−1,y−1), −Q(x,y−1), −Q(x+1, y−1), −Q(x+2,y−1), −Q(x−2,y), and −Q(x−1,y).

The processing order for the pixels explained with reference to FIG. 4 and the quantization error use area are the same for the gradation converting unit 42.

### A Configuration Example of the Two-Dimensional Filter 55

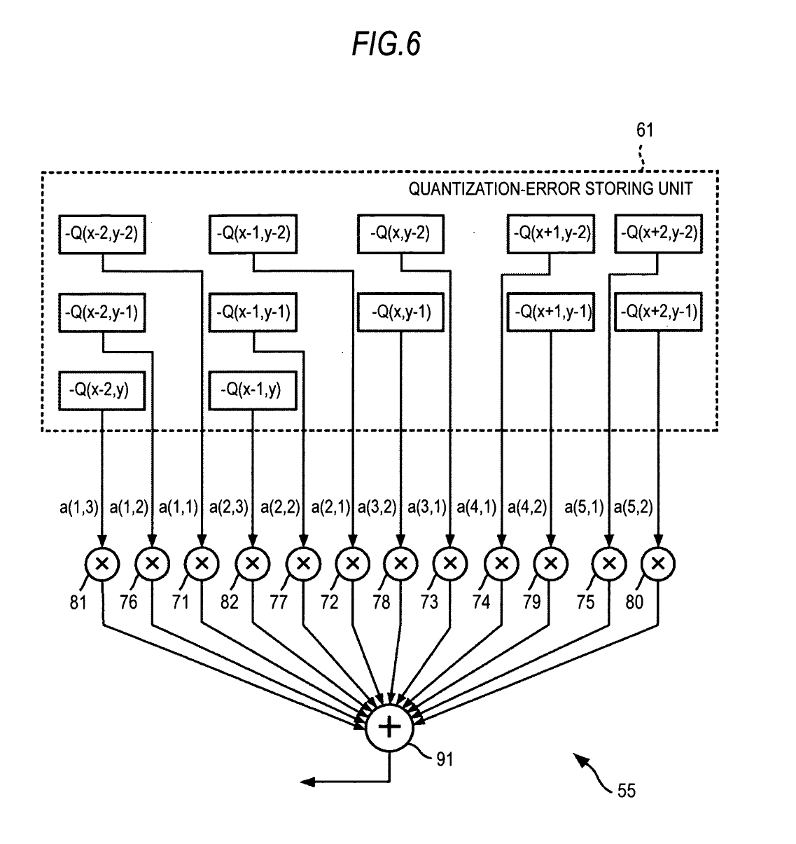

FIG. 6 is a diagram of a configuration example of the two-dimensional filter 55 shown in FIG. 3.

The two-dimensional filter 55 includes a quantization-error storing unit 61, multiplying units 71 to 82, and an adding unit 91 and configures a FIR (Finite Impulse Response) filter.

The quantization-error storing unit 61 stores quantization errors in the past used in performing the ΔΣ modulation and outputs plural quantization errors in the past according to processing target pixels. When the pixel values IN(x,y) of the pixels (x,y) are subjected to the ΔΣ modulation, the quantization-error storing unit 61 outputs the twelve quantization errors −Q(x−2,y−2) to −Q(x−1,y) shown in FIG. 6.

The multiplying unit 71 multiplies together the quantization error −Q(x−2,y−2) supplied from the quantization-error storing unit 61 and a filter coefficient a₁(1,1) and outputs a result of the multiplication to the adding unit 91. The multiplying unit 72 multiplies together the quantization error −Q(x−1,y−2) supplied from the quantization-error storing unit 61 and a filter coefficient a₁(2,1) and outputs a result of the multiplication to the adding unit 91. The multiplying unit 73 multiplies together the quantization error −Q(x,y−2) supplied from the quantization-error storing unit 61 and a filter coefficient a₁(3,1) and outputs a result of the multiplication to the adding unit 91. The multiplying unit 74 multiplies together the quantization error −Q(x+1,y−2) supplied from the quantization-error storing unit 61 and a filter coefficient a₁(4,1) and outputs a result of the multiplication to the adding unit 91. The multiplying unit 75 multiplies together the quantization error −Q(x+2,y−2) supplied from the quantization-error storing unit 61 and a filter coefficient a₁(5,1) and outputs a result of the multiplication to the adding unit 91.

Similarly, the multiplying units 76 to 80 respectively multiply together the quantization errors −Q(x−2,y−1) to −Q(x+2,y−1) and filter coefficients a₁(1,2) to a₁(5,2) and output results of the multiplication to the adding unit 91. Similarly, the multiplying units 81 and 82 respectively multiply together the quantization errors −Q(x−2,y) and −Q(x−1,y) and filter coefficients a₁(1,3) and a₁(2,3) and output results of the multiplication to the adding unit 91.

The adding unit 91 adds up the outputs of the multiplying units 71 to 82 and outputs a result of the addition.

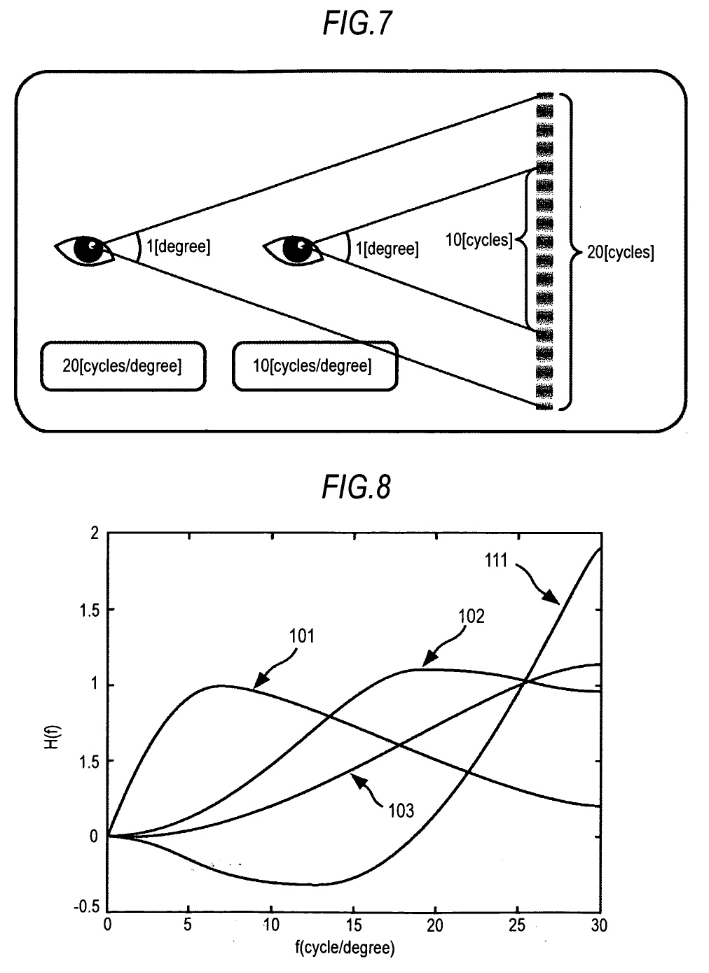

The twelve filter coefficients a₁(1,1) to a₁(2,3) are values determined to be amplitude characteristics of noise shaping explained later with reference to FIGS. 7 and 8 and are stored in the two-dimensional filter 55 in advance.

### [Explanation of an Amplitude Characteristic of Noise Shaping by the Gradation Converting Unit 41]

The pixel values IN(x,y) of the pixels (x,y) as the input to the gradation converting unit 41 and the pixel values OUT(x,y) of the pixels (x,y) as the output from the gradation converting unit 41 have a relation represented by the following formula:

OUT(x,y)=IN(x,y)−(1−G)×Q(x,y) (1)

In Formula (I), G represents a transfer function of the two-dimensional filter 55. According to Formula (I), the quantization errors Q(x,y) are modulated into a high-frequency band by noise shaping of a transfer function (1−G).

An image after gradation conversion by the gradation converting unit 41 is finally displayed on the display connected via the HDMI output terminal 21. Therefore, from the viewpoint of improving an image quality of the image displayed on the connected display, concerning a spatial frequency characteristic of the human vision, spatial frequencies up to a maximum spatial frequency of the image displayed on the display only have to be taken into account.

The maximum spatial frequency of the image displayed on the display can be obtained as a spatial frequency in a unit of cycle/degree from the resolution of the display and a viewing distance. The viewing distance means a distance from a viewer to the display in viewing the image displayed on the display.

The maximum spatial frequency of the image displayed on the display depends on the resolution of the display. Therefore, the maximum spatial frequency is also referred to as a spatial frequency corresponding to the resolution as appropriate.

When the length in the vertical direction (the longitudinal length) of the display is represented as H inch, as the viewing distance, for example, length of about 2.5H to 3.0H is adopted.

For example, when the display has a 40-inch size including 1920×1080 pixels for displaying a so-called full HD (High Definition) image, the maximum spatial frequency of the image displayed on the display is 30 cycles/degree.

FIG. 7 is a diagram for explaining cycle/degree as a unit of a spatial frequency.

Cycle/degree represents the number of stripe patterns seen in a range of a unit angle with respect to an angular field of view. For example, 10 cycles/degree means that ten pairs of white lines and black lines are seen in a range of an angular field of view of 1 degree. 20 cycles/degree means that twenty pairs of white lines and black lines are seen in the range of the angular field of view of 1 degree.

FIG. 8 is a graph of a human vision characteristic 101 and an amplitude characteristic 111 of noise shaping by the ΔΣ modulation by the gradation converting unit 41 obtained when the maximum spatial frequency of the image displayed on the display is set to 30 cycles/degree.

The characteristic 101 represents a spatial frequency characteristic of human vision (a vision characteristic). An amplitude characteristic 102 represents an amplitude characteristic of noise shaping performed by using the Jarvis filter in the past. An amplitude characteristic 103 represents an amplitude characteristic of noise shaping performed by using the Floyd filter in the past. On the other hand, the amplitude characteristic 111 represents an amplitude characteristic of noise shaping performed by using the two-dimensional filter 55.

The abscissa represents a spatial frequency f [cycle/degree]. Concerning the human vision characteristic 101, the ordinate represents contrast sensitivity. Concerning the amplitude characteristics 102, 103, and 111 of the noise shaping, the ordinate represents a gain.

In FIG. 8, the human vision characteristic 101 reaches a peak value when the spatial frequency f is 7 cycles/degree. The human vision characteristic 101 is attenuated until the spatial frequency f increases to 30 cycles/degree. On the other hand, the amplitude characteristic 111 of the noise shaping by the gradation converting unit 41 is attenuated in a minus direction until the spatial frequency f increases to near 12 cycles/degree. Thereafter, the amplitude characteristic 111 steeply rises and draws a curve having a peak value at 30 cycles/degree. Specifically, the amplitude characteristic 111 is adapted to reduce a quantization error in a low-frequency component up to about ⅔ of the maximum frequency of the spatial frequency of the image that can be displayed on the display. The quantization error is modulated to a frequency band having sufficiently low sensitivity with respect to the human vision characteristic 101.

A filter coefficient of the filtering by the two-dimensional filter 55 is determined on the basis of the human vision characteristic 101 as explained below. The filter coefficient is determined such that, in a frequency band equal to or lower than the spatial frequency corresponding to the resolution of the display, a characteristic of a frequency band equal to or higher than an intermediate frequency band of the noise shaping by the gradation converting unit 41 is a characteristic opposite to that of the human vision characteristic 101.

In the amplitude characteristic 111 shown in FIG. 8, i.e., the amplitude characteristic 111 of the noise shaping by the gradation converting unit 41, a gain is maximized at 30 cycles/degree, which is the spatial frequency corresponding to the resolution of the display. In the spatial frequency 111 shown in FIG. 8, a characteristic of a frequency band equal to or higher than the intermediate frequency band in frequency bands (from 0 cycle/degree) up to the spatial frequency corresponding to the resolution of the display is a characteristic opposite to that of the human vision characteristic 101 (hereinafter also referred to as opposite characteristic as appropriate). In other words, the characteristic of the frequency band equal to or higher than the intermediate frequency band is, so to speak, a characteristic of a HPF (High Pass Filter).

The amplitude characteristic 111 of the noise shaping by the gradation converting unit 41 more steeply increase in a high frequency band than the amplitude characteristic 103 of the noise shaping performed by using the Floyd filter.

Therefore, according to the noise shaping having the amplitude characteristic 111, a higher frequency component with low sensitivity of human vision among quantization errors included in the pixel values OUT(x,y) of the image after the gradation conversion is large. According to the noise shaping having the amplitude characteristic 111, an intermediate frequency band including a frequency near 7 cpd with high human vision sensitivity is small.

As a result, it is possible to prevent quantization errors as noise from being visually recognized in the image after the gradation conversion and improve an image quality in appearance.

The amplitude characteristic of the frequency band equal to or higher than the intermediate frequency band of the noise shaping does not need to completely coincide with the opposite characteristic of the human vision. In other words, the amplitude characteristic of the frequency band equal to or higher than the intermediate frequency band of the noise shaping only has to be similar to the opposite characteristic of the human vision.

The entire amplitude characteristic of the noise shaping can be set to the characteristic opposite to the vision characteristic 101.

Specifically, according to the vision characteristic 101 shown in FIG. 8, as a frequency component with low sensitivity of human vision, there is a frequency component in a low frequency band besides the frequency component in the high frequency band. Therefore, as the amplitude characteristic of the noise shaping, a characteristic of a so-called band-pass filter that causes frequency components in the high and low frequency bands to pass can be adopted.

However, when the characteristic of the band-pass filter is adopted as the amplitude characteristic of the noise shaping, the number of taps of the amplitude characteristic of the noise shaping increases, the apparatus increases in size, and cost increases.

Therefore, for example, from the viewpoint of the size of the apparatus and cost, as the amplitude characteristic of the noise shaping, it is desirable to adopt the characteristic of the HPF shown in FIG. 8 having the amplitude characteristic of the frequency band equal to or higher than the intermediate frequency band opposite to the characteristic of human vision.

In FIG. 8, the amplitude characteristic 111 by the gradation converting unit 41 far exceeds the gain 1 in the high-frequency band. This indicates that a quantization error in the high-frequency band is more substantially amplified than that amplified when the Jarvis filter or the Floyd filter is used.

In FIG. 8, in the amplitude characteristic 111 of the noise shaping by the gradation converting unit 41, a gain is minus from the low-frequency band to the intermediate frequency band. This makes it possible to configure the two-dimensional filter 55 with a two-dimensional filter having a smaller number of taps. In other words, a more natural image quality can be obtained by a simpler configuration.

### [Gradation Modulation Output Processing by a Digital Signal]

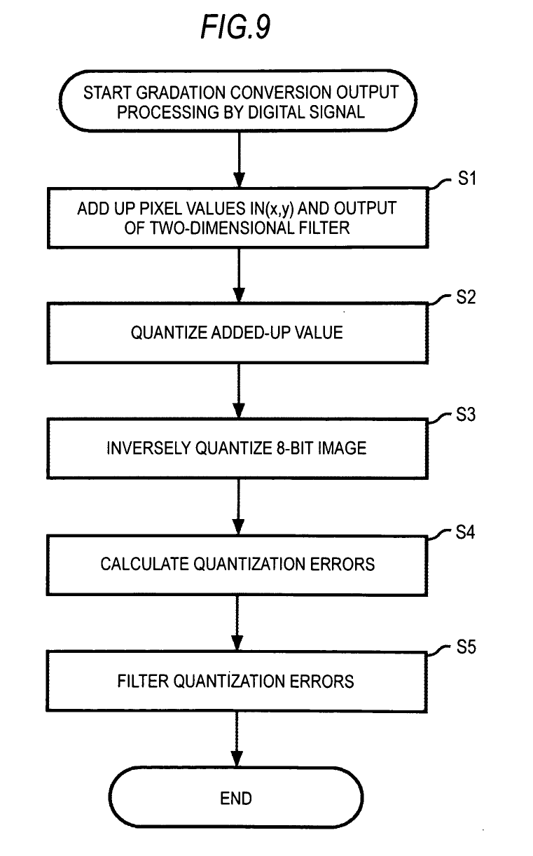

FIG. 9 is a flowchart for explaining gradation conversion output processing for outputting a digital image signal after the gradation conversion.

First, in step S1, the arithmetic unit 51 adds up the supplied pixel values IN(x,y) and the output of the two-dimensional filter 55 and supplies an added-up value obtained as a result of the addition to the quantization unit 52 and the arithmetic unit 54.

In step S2, the quantization unit 52 quantizes the added-up value supplied from the arithmetic unit 51 into 8 bits and outputs an 8-bit quantized value obtained as a result of the quantization as pixel values OUT(x,y) of the pixels (x,y) of the image after the gradation conversion. That is, the quantizing unit 52 quantizes the added-up value supplied from the arithmetic unit 51 and outputs a quantized value including quantization errors as a result of the ΔΣ modulation (a result of the gradation conversion by the ΔΣ modulation).

In step S3, the inverse quantization unit 53 inversely quantizes the 8-bit image supplied from the quantization unit 52 into a 12-bit image and supplies an inversely-quantized value obtained as a result of the inverse quantization to the arithmetic unit 54.

In step S4, the arithmetic unit 54 subtracts the inversely-quantized pixel values OUT(x,y) from the added-up value supplied from the arithmetic unit 51 to calculate quantization errors −Q(x,y) caused by the quantization in the quantization unit 52. The calculated quantization errors −Q(x,y) are supplied to the two-dimensional filter 55.

In step S5, the two-dimensional filter 55 filters the quantization errors −Q(x,y) supplied from the arithmetic unit 54 and supplies a result of the filtering to the arithmetic unit 51.

With the pixel values IN(x,y) of the pixels (x,y) of the image, which are supplied to the gradation converting unit in raster scan order, sequentially set as a pixel of attention, the processing in steps S1 to S5 is repeated.

In the two-dimensional filter 55 of the gradation converting unit 41, a filtering coefficient of the filtering is determined such that the characteristic of the frequency band equal to or higher than the intermediate frequency band of the amplitude characteristic of the noise shaping by the ΔΣ modulation is a characteristic opposite to the human vision characteristic 101 like the amplitude characteristic 111 shown in FIG. 8. Therefore, since quantization errors as noise are less easily visually recognized, an image quality in appearance of an image after the gradation conversion can be improved.

When an image as a target of the gradation conversion (a conversion target image) in the gradation converting unit 41 has plural components such as Y, Cb, and Cr as pixel values, the gradation conversion processing shown in FIG. 9 is independently performed for each of the components. In other words, when the conversion target image has Y components, Cb components, and Cr components as pixel values, the gradation converting unit 41 performs the gradation conversion processing shown in FIG. 9 targeting only the Y components. Similarly, the gradation converting unit 41 performs the gradation conversion processing shown in FIG. 9 targeting only the Cb components and performs the gradation conversion processing shown in FIG. 9 targeting only the Cr components.

Gradation conversion processing for analog output is explained.

First, a relation between an amplitude characteristic of noise shaping by the gradation converting unit 42 for analog output and the frequency characteristic of the DA converter 43 is explained.

### [The Frequency Characteristic of the DA Converter 43]

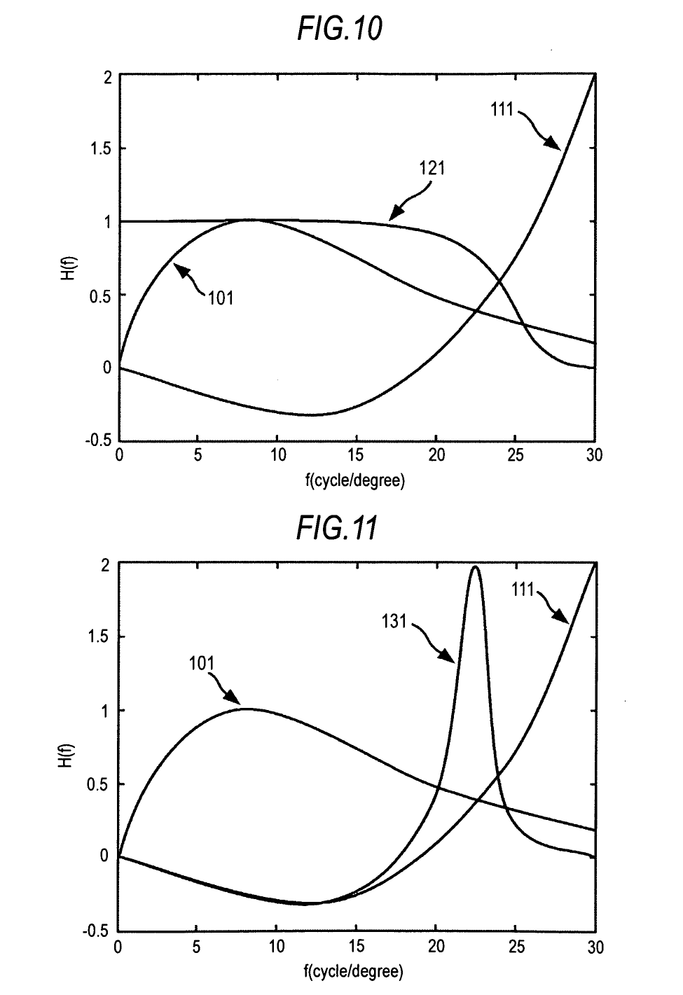

FIG. 10 is a graph of a frequency characteristic 121 of the DA converter 43.

In FIG. 10, to facilitate comparison, the human vision characteristic 101 and the amplitude characteristic 111 of the noise shaping by the gradation converting unit 41 are also shown.

The frequency characteristic 121 of the DA converter generally maintains 1 until the spatial frequency f increases to near 20 cycles/degree. Thereafter, the frequency characteristic 121 is attenuated. In particular, at 25 cycles/degree or higher spatial frequency, a gain is equal to or smaller than 0.5. The frequency characteristic 121 is substantially deteriorated.

Therefore, if the amplitude characteristic 111 of the noise shaping by the gradation converting unit 41 is adopted as the amplitude characteristic of the noise shaping by the gradation converting unit 42, as shown in FIG. 10, most of modulated high-frequency components are lost. In other words, an image quality in appearance of an image after the gradation conversion is deteriorated.

### [Explanation of the Amplitude Characteristic of the Noise Shaping by the Gradation Converting Unit 42]

Therefore, the amplitude characteristic of the noise shaping of the gradation converting unit 42 is determined to be an amplitude characteristic 131 shown in FIG. 11 according to the frequency characteristic 121 of the DA converter 43.

FIG. 11 is a graph of the amplitude characteristic 131 of the noise shaping by the gradation converting unit 42.

The amplitude characteristic 131 of the gradation converting unit 42 draws a curve with a gain reaching a peak value at a spatial frequency 22.5 lower by a second value than a spatial frequency near 25 cycles/degree, which is a spatial frequency of a first value indicating attenuation of the gain in the frequency characteristic 121 of the DA converter 43, and thereafter being attenuated. The frequency of the first value indicating the attenuation of the gain can be set to, for example, a spatial frequency with a gain 0.5. The second value can be set to, for example, 2.5 (=25-22.5) but is not limited to this.

Specifically, like the amplitude characteristic 131, the amplitude characteristic of the noise shaping by the gradation converting unit 42 only has to draw a curve with a gain reaching a peak value at a spatial frequency lower by the second value than the spatial frequency of the first value indicating attenuation of the gain in the frequency characteristic 121 of the DA converter 43, steeply increasing to the peak, and steeply decreasing after the peak. As in the amplitude characteristic 111 of the noise shaping by the gradation converting unit 41, the spatial frequency f is attenuated in the minus direction to near 12 cycles/degree.

When compared with the amplitude characteristic 111 of the noise shaping by the gradation converting unit 41, it can be said that, in the amplitude characteristic 131 of the noise shaping by the gradation converting unit 42, the peak value is moved to a lower spatial frequency. In other words, in the amplitude characteristic 131 of the noise shaping by the gradation converting unit 42, a spatial frequency of the peak value of the gain is lower than that of the amplitude characteristic 111 of the noise shaping by the gradation converting unit 41.

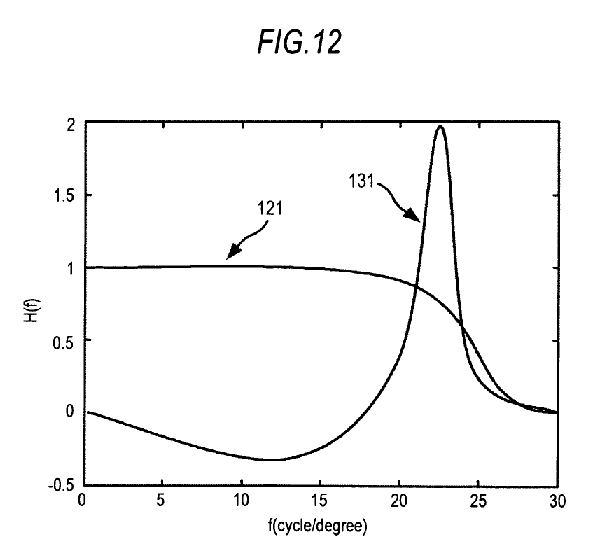

FIG. 12 is a graph in which the frequency characteristic 121 of the DA converter 43 and the amplitude characteristic 131 of the noise shaping by the gradation converting unit 42 are shown.

As it is seen with reference to FIG. 12, when the amplitude characteristic 131 of the noise shaping is adopted as the amplitude characteristic of the gradation converting unit 42, quantization errors are not modulated to high-frequency components that are deleted by the DA converter 43. However, the quantization errors are modulated to highest-frequency components among bands caused to pass by the DA converter 43.

In other words, the quantization errors are modulated to as high-frequency components as possible among frequency bands caused to pass (not deteriorated) by the DA converter 43. As a result, even after DA conversion by the DA converter 43, it is possible to prevent quantization errors as noise from being visually recognized in an image after the gradation conversion and improve an image quality in appearance.

### [A Configuration of the Gradation Converting Unit 42]

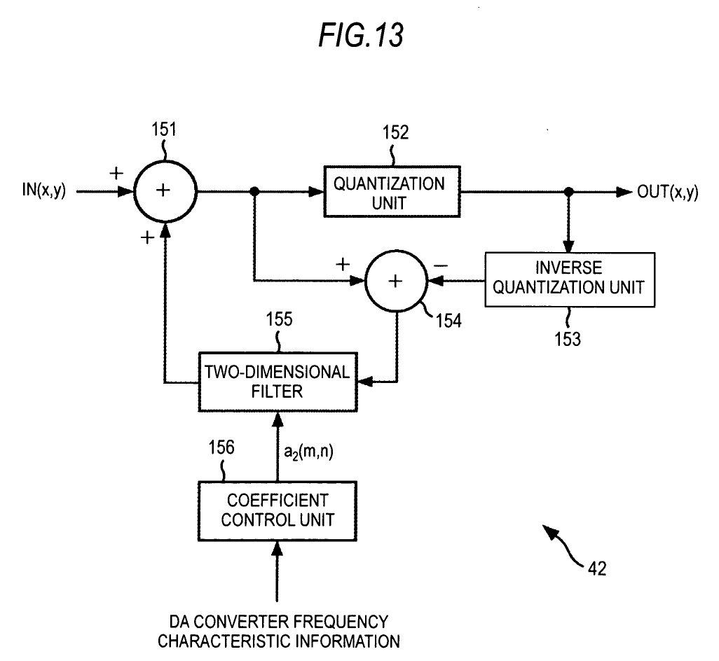

FIG. 13 is a block diagram of a detailed configuration example of the gradation converting unit 42.

The gradation converting unit 42 includes an arithmetic unit 151, a quantization unit 152, an inverse quantization unit 153, an arithmetic unit 154, a two-dimensional filter 155, and a coefficient control unit 156.

The pixel values IN(x,y) of the pixels (x,y) of the 12-bit image as a target image of the gradation conversion (a conversion target image) are supplied to the arithmetic unit 151 in raster scan order. Output of the two-dimensional filter 155 is also supplied to the arithmetic unit 151.

The arithmetic unit 151 adds up the pixel values IN(x,y) and the output of the two-dimensional filter 155 and supplies an added-up value obtained as a result of the addition to the quantization unit 152 and the arithmetic unit 154.

The quantization unit 152 quantizes the added-up value supplied from the arithmetic unit 151 into 8 bits by truncating LSB 4 bits. A quantized value obtained as a result of the quantization is output as the pixel values OUT(x,y) of the pixels (x,y) of an image after the gradation conversion and supplied to the inverse quantization unit 153. In this embodiment, analog output is fixed to an 8-bit image. However, the analog output can be changed as in the gradation converting unit 41.

Like the inverse quantization unit 53 shown in FIG. 3, the inverse quantization unit 153 inversely quantizes the 8-bit image supplied from the quantization unit 152 into a 12-bit image and supplies an inversely-quantized value obtained as a result of the inverse quantization to the arithmetic unit 154.

The arithmetic unit 154 subtracts the pixel values OUT(x,y) after the inverse quantization, which are supplied from the inverse quantization unit 153, from the added-up value supplied from the arithmetic unit 151 to calculate the quantization errors −Q(x,y) caused by the quantization by the quantization unit 152 and supplies the quantization errors −Q(x,y) to the two-dimensional filter 155. In other words, the arithmetic unit 154 subtracts output from the quantization unit 152 from input to the quantization unit 152 to calculate the quantization errors −Q(x,y) caused by the quantization by the quantization unit 152.

The two-dimensional filter 155 is a two-dimensional filter that filters a signal. The two-dimensional filter 155 filters the quantization errors −Q(x,y) supplied from the arithmetic unit 154 and outputs a result of the filtering to the arithmetic unit 151. Filter coefficients a₂(m,n) (m=1 to 5 and n=1 to 3) for filtering a signal are supplied from the coefficient control unit 156.

The arithmetic unit 151 adds up the result of the filtering of the quantization errors −Q(x,y) output by the two-dimensional filter 155 as explained above and the pixel values IN(x,y).

The coefficient control unit 156 acquires the DA converter frequency characteristic information supplied from the CPU 11. For example, the spatial frequency f, a gain of which is reduced in the frequency characteristic 121 of the DA converter 43, is supplied to the coefficient control unit 156 as the DA converter frequency characteristic information.

The coefficient control unit 156 determines the filter coefficients a₂(m,n) on the basis of the DA converter frequency characteristic information and supplies the filter coefficients a₂(m,n) to the two-dimensional filter 155. For example, the coefficient control unit 156 has a table in which values of the spatial frequency f and the filter coefficients a₂(m,n) are associated. The coefficient control unit 156 supplies the filter coefficients a₂(m,n) stored in association with the spatial frequency f, which is the DA converter frequency characteristic information, to the two-dimensional filter 155. When it is unnecessary to change the filter coefficients a₂(m,n), the coefficient control unit 156 may be omitted and the filter coefficient a₂(m,n) set in advance may be stored in the two-dimensional filter 155.

In the gradation converting unit 42, as in the gradation converting unit 41, the quantization errors −Q(x,y) are fed back to the input side (the arithmetic unit 151) via the two-dimensional filter 155 to configure a two-dimensional ΔΣ modulator.

### A Configuration Example of the Two-Dimensional Filter 155

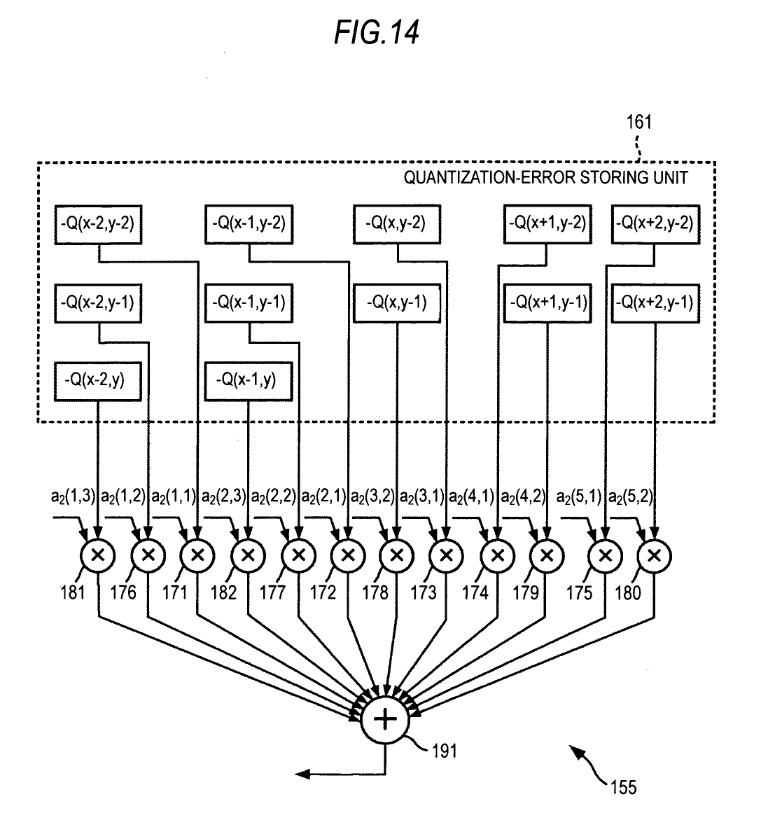

FIG. 14 is a diagram of a configuration example of the two-dimensional filter 155 shown in FIG. 13.

The two-dimensional filter 155 includes a quantization-error storing unit 161, multiplying units 171 to 182, and an adding unit 191 and configures a FIR (Finite Impulse Response) filter.

The quantization-error storing unit 161 stores quantization errors in the past used in performing the ΔΣ modulation and outputs plural quantization errors in the past according to processing target pixels. When the pixel values IN(x,y) of the pixels (x,y) are subjected to the ΔΣ modulation, the quantization-error storing unit 161 outputs the twelve quantization errors −Q(x−2,y−2) to −Q(x−1,y) shown in FIG. 14.

The multiplying unit 171 multiplies together the quantization error −Q(x−2,y−2) supplied from the quantization-error storing unit 161 and a filter coefficient a₂(1,1) and outputs a result of the multiplication to the adding unit 191. The multiplying unit 172 multiplies together the quantization error −Q(x−1,y−2) supplied from the quantization-error storing unit 161 and a filter coefficient a₂(2,1) and outputs a result of the multiplication to the adding unit 191. The multiplying unit 173 multiplies together the quantization error −Q(x,y−2) supplied from the quantization-error storing unit 161 and a filter coefficient a₂(3,1) and outputs a result of the multiplication to the adding unit 191. The multiplying unit 174 multiplies together the quantization error −Q(x+1,y−2) supplied from the quantization-error storing unit 161 and a filter coefficient a₂(4,1) and outputs a result of the multiplication to the adding unit 191. The multiplying unit 175 multiplies together the quantization error −Q(x+2,y−2) supplied from the quantization-error storing unit 161 and a filter coefficient a₂(5,1) and outputs a result of the multiplication to the adding unit 191.

Similarly, the multiplying units 176 to 180 respectively multiply together the quantization errors −Q(x−2,y−1) to −Q(x+2,y−1) and filter coefficients a₂(1,2) to a₂(5,2) and output results of the multiplication to the adding unit 191. Similarly, the multiplying units 181 and 182 respectively multiply together the quantization errors −Q(x−2,y) and −Q(x−1,y) and filter coefficients a₂(1,3) and a₂(2,3) and output results of the multiplication to the adding unit 191.

The adding unit 191 adds up the outputs of the multiplying units 171 to 182 and outputs a result of the addition.

The twelve filter coefficients a₂(1,1) to a₂(2,3) are values determined to be the amplitude characteristic 131 (FIG. 12) of the noise shaping according to the frequency characteristic 121 (FIG. 12) of the DA converter 43, and are supplied from the coefficient control unit 156.

### [Gradation Conversion Output Processing by an Analog Signal]

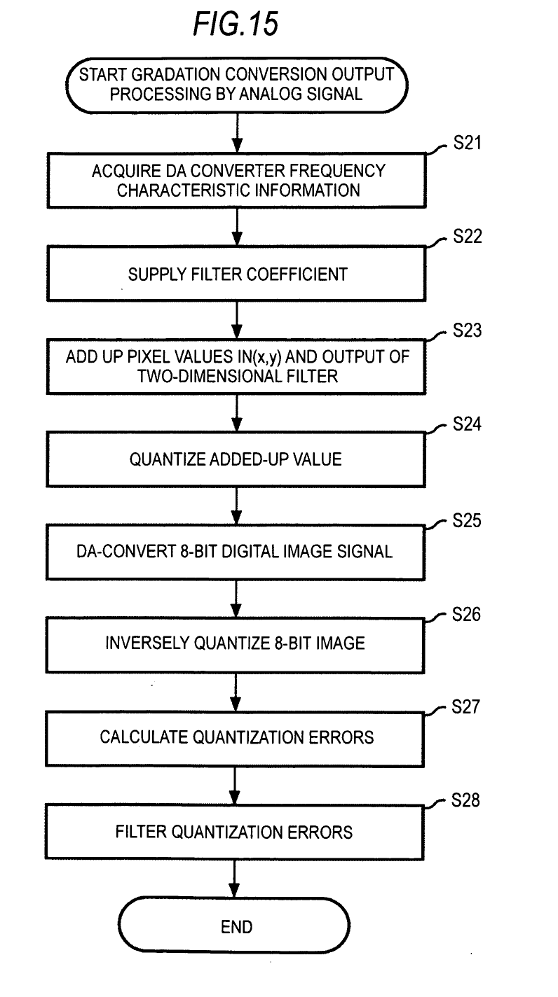

FIG. 15 is a flowchart for explaining gradation conversion output processing for outputting an analog image signal after the gradation conversion.

First, in step S21, the coefficient control unit 156 acquires the DA converter frequency characteristic information supplied from the CPU 11.

In step S22, the coefficient control unit 156 determines the filter coefficients a₂(m,n) on the basis of the DA converter frequency characteristic information and supplies the filter coefficient a₂(m,n) to the two-dimensional filter 155.

In step S23, the arithmetic unit 151 adds up the supplied pixel values IN(x,y) and output of the two-dimensional filter 155 and supplies an added-up value obtained as a result of the addition to the quantization unit 152 and the arithmetic unit 154.

In step S24, the quantization unit 152 quantizes the added-up value supplied from the arithmetic unit 151 into 8 bits and outputs an 8-bit quantized value obtained as a result of the quantization to the inverse quantization unit 153 and the DA converter 43 as the pixel values OUT(x,y) of the pixels (x,y) of an image after the gradation conversion. In other words, the quantization unit 52 quantizes the added-up value supplied from the arithmetic unit 51 and outputs a quantized value including quantization errors to the inverse quantization unit 153 and the DA converter 43 as a result of the ΔΣ modulation (a result of the gradation conversion by the ΔΣ modulation).

In step S25, the DA converter 43 converts an 8-bit digital image signal after the gradation conversion from the gradation converting unit 42 into an analog signal (DA conversion) and outputs the analog signal to the analog I/F 20.

In step S26, the inverse quantization unit 153 inversely quantizes the 8-bit image into a 12-bit image and supplies an inversely-quantized value obtained as a result of the inverse quantization to the arithmetic unit 154.

In step S27, the arithmetic unit 154 subtracts the inversely-quantized pixel values OUT(x,y) from the added-up value supplied from the arithmetic unit 151 to calculate the quantization errors −Q(x,y) caused by the quantization by the quantization unit 152. The obtained quantization errors −Q(x,y) are supplied to the two-dimensional filter 155.

In step S28, the two-dimensional filter 155 filters the quantization errors −Q(x,y) supplied from the arithmetic unit 154 and supplies a result of the filtering to the arithmetic unit 151.

With the pixel values IN(x,y) of the pixels (x,y) of the image, which are supplied to the gradation converting unit in raster scan order, sequentially set as a pixel of attention, the processing in steps S21 to S28 is repeated.

In the two-dimensional filter 155 of the gradation converting unit 42, the filtering coefficients a₂(m,n) are determined such that quantization errors are modulated to as high-frequency components as possible among frequency bands caused to pass by the DA converter 43. Therefore, since quantization errors as noise are less easily visually recognized, an image quality in appearance of an image after the gradation conversion can be improved.

In other words, it is possible to cause the display to display a high-quality image as in digital output even when an image signal is converted via the DA converter 43.

As in the gradation converting unit 41, when an image as a target of the gradation conversion in the gradation converting unit 42 has plural components such as Y, Cb, and Cr as pixel values, the gradation conversion processing shown in FIG. 15 is independently performed for each of the components.

### A Second Configuration Example of the Image Processing Unit 18

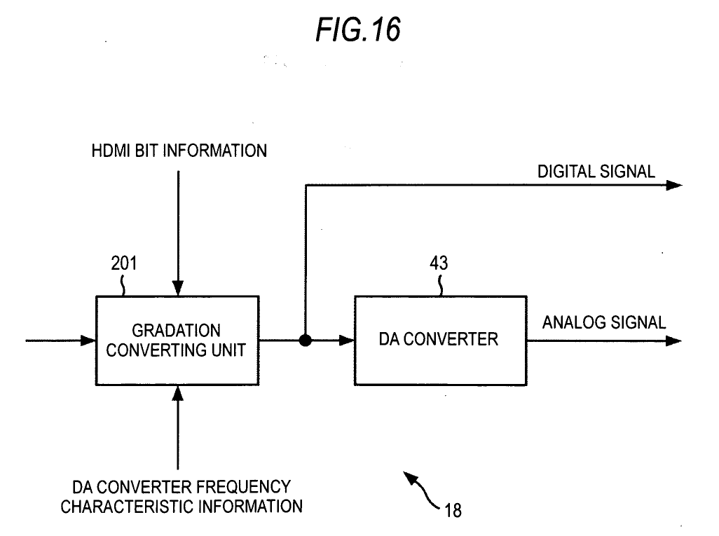

FIG. 16 is a block diagram of another configuration example of the image processing unit 18.

In the first configuration of the image processing unit 18 shown in FIG. 2, the gradation converting units are provided for both digital output and analog output. On the other hand, the image processing unit 18 shown in FIG. 16 includes one gradation converting unit 201 common to digital output and analog output. This makes it possible to realize, with a configuration simpler than that shown in FIG. 2, output of a high-quality image after the gradation conversion as both the digital output and the analog output.

The image processing unit 18 shown in FIG. 16 includes the gradation converting unit 201 and the DA converter 43.

HDMI bit information and DA converter frequency characteristic information are supplied to the gradation converting unit 201 from the CPU 11 (FIG. 1).

In the HDMI®, it is possible to detect whether apparatuses are connected by the HDMI®. The CPU 11 determines, on the basis of the HDMI control information, whether the display is connected to the HDMI I/F output terminal 19. When the display is connected to the HDMI I/F output terminal 19, the CPU 11 selects the digital output and supplies HDMI bit information and DA converter frequency characteristic information for the digital output to the gradation converting unit 201. On the other hand, when the display is not connected to the HDMI I/F output terminal 19, the CPU 11 selects the analog output and supplies HDMI bit information and DA converter frequency characteristic information for the analog output to the gradation converting unit 201.

The gradation converting unit 201 performs the gradation conversion processing on the basis of the HDMI bit information and the DA converter frequency characteristic information. For example, the gradation converting unit 201 gradation-converts a 12-bit image supplied from the AV decoder 17 into an 8-bit image.

The DA converter 43 converts an 8-bit digital image signal after the gradation conversion from the gradation converting unit 42 into an analog signal and outputs the analog signal to the analog I/F 20.

### [A Configuration of the Gradation Converting Unit 201]

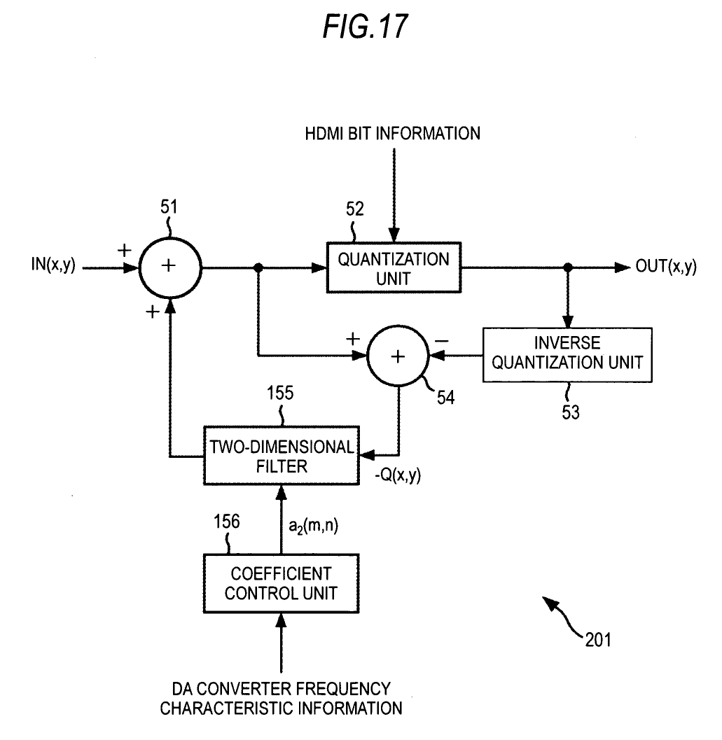

FIG. 17 is a block diagram of a detailed configuration example of the gradation converting unit 201. In FIG. 17, components corresponding to those shown in FIGS. 3 and 13 are denoted by the same reference numerals and signs. Explanation of the components is omitted as appropriate.

The gradation converting unit 201 includes the arithmetic unit 51, the quantization unit 52, the inverse quantization unit 53, the arithmetic unit 54, the two-dimensional filter 155, and the coefficient control unit 156.

The quantization unit 52 quantizes an added-up value supplied from the arithmetic unit 51 into 8 bits represented by the HDMI bit information.

The coefficient control unit 156 determines the filter coefficients a₂(m,n) on the basis of the DA converter frequency characteristic information and supplies the filter coefficients a₂(m,n) to the two-dimensional filter 155.

For example, when the digital output is selected, the spatial frequency f=30 as the DA converter frequency characteristic information is supplied from the CPU 11. For example, when the analog output is selected, the spatial frequency f=22.5 as the DA converter frequency characteristic information is supplied from the CPU 11.

In the table stored in the coefficient control unit 156, for example, for f=30, the filter coefficients a₂(m,n) corresponding to the amplitude characteristic 111 of the noise shaping shown in FIG. 11 are stored. For f=22.5, the filter coefficients a₂(m,n) corresponding to the amplitude characteristic 131 of the noise shaping shown in FIG. 11 are stored. In this example, the spatial frequency f as the supplied DA converter frequency characteristic information and the peak value of the amplitude characteristic of the noise shaping are set the same. However, it is not always necessary to set the spatial frequency f and the peak value the same.

Besides, it is also possible to store the spatial frequency f and the filter coefficients a₂(m,n) in association with the resolution of the display and a model (type) of the display acquired from the display connected via the HDMI output terminal 21 and change the spatial frequency f and the filter coefficients a₂(m,n) according to the resolution and the model. Therefore, it is possible to store and switch plural kinds of filter coefficients a₂(m,n) for each of the digital output and the analog output. In that sense, the spatial frequency f supplied from the CPU 11 is not limited to information representing the frequency characteristic of the DA converter 43. Therefore, spatial frequency f can be referred to as filter coefficient control information.

In the case of the digital output, the gradation conversion output processing performed by the image processing unit 18 is the same as the processing explained with reference to FIG. 9. In the case of the analog output, the gradation conversion output processing is the same as the processing explained with reference to FIG. 15.

Consequently, in the second configuration of the image processing unit 18, as in the first configuration, for both the digital output and the analog output, it is possible to prevent quantization errors as noise from being visually recognized in an image after the gradation conversion and improve an image quality in appearance.

The present invention applied to the gradation control in the recording and reproducing apparatus has been explained. However, the present invention can be applied to gradation conversion in every apparatus that treats an image such as a television receiver as long as the apparatus includes both the digital output and the analog output.

The processing of the gradation conversion may be incorporated in an apparatus as a predetermined block like the image processing unit 18 or may be configured as an independent apparatus (an image processing apparatus).

In this specification, processing steps describing a computer program for causing the computer to execute various kinds of processing do not always have to be processed in time series according to the order described as the flowcharts. Therefore, the processing steps may be processing executed in parallel or individually (e.g., parallel processing or processing by an object).

Embodiments of the present invention are not limited to the embodiments explained above. Various modifications of the embodiments are possible without departing from the spirit of the present invention.

What is claimed is:

1. An image processing apparatus comprising:
ΔΣ modulation means for applying ΔΣ modulation to an image to thereby convert gradation of the image;
analog conversion means for converting a signal of the image, the gradation of which is converted by the ΔΣ modulation means, into an analog signal;
digital output means for outputting a digital signal of the image after gradation conversion; and
analog output means for outputting an analog signal of the image after gradation conversion, wherein
the ΔΣ modulation means includes
arithmetic means for filtering a quantization error;
adding means for adding up a pixel value of the image and output of the arithmetic means;
quantization means for quantizing output of the adding means and outputting a quantized value including the quantization error as a result of the ΔΣ modulation; and
subtracting means for calculating a difference between the output of the adding means and the quantized value of the output of the adding means to thereby calculate the quantization error, and
a filter coefficient for the filtering by the arithmetic means corresponding to the analog output is determined according to a frequency characteristic of the analog conversion means.

2. An image processing apparatus according to claim 1, wherein the filter coefficient for the filtering by the arithmetic means corresponding to the analog output is determined such that a gain of an amplitude characteristic of noise shaping performed by the ΔΣ modulation means reaches a peak value at a spatial frequency lower by a second value than a spatial frequency of a first value indicating attenuation of the gain in the frequency characteristic of the analog conversion means and is attenuated at a spatial frequency equal to or higher than the first value.

3. An image processing apparatus according to claim 2, wherein the filtering coefficient for the filtering by the arithmetic means corresponding to digital output is determined such that a characteristic of a frequency band equal to or higher than an intermediate frequency band of the amplitude characteristic of the noise shaping performed by the ΔΣ modulation means is a characteristic opposite to a spatial frequency characteristic of human vision.

4. An image processing apparatus according to claim 3, wherein the spatial frequency at which the gain of the amplitude characteristic of the noise shaping corresponding to the analog output reaches the peak value is lower than a spatial frequency at which a gain of an amplitude characteristic of noise shaping corresponding to the digital output reaches a peak value.

5. An image processing apparatus according to claim 4, further comprising selecting means for selecting one of the digital output and the analog output, wherein
the filtering coefficient for the filtering by the arithmetic means is changed according to the selected digital output or analog output.

6. An image processing apparatus according to claim 4, wherein the ΔΣ modulation means is provided for each of the digital output and the analog output.

7. An image processing apparatus according to claim 4, further comprising control means for storing plural kinds of filter coefficients for the filtering by the arithmetic means and supplying a predetermined filter coefficient to the arithmetic means out of the stored filter coefficients according to filter coefficient control information for switching the filter coefficients.

8. An image processing method for an image processing apparatus including ΔΣ modulation means for applying ΔΣ modulation to an image to thereby convert gradation of the image; analog conversion means for converting a signal of the image, the gradation of which is converted by the ΔΣ modulation means, into an analog signal; digital output means for outputting a digital signal of the image after gradation conversion; and analog output means for outputting an analog signal of the image after gradation conversion, the ΔΣ modulation means including
arithmetic means for filtering a quantization error;
adding means for adding up a pixel value of the image and output of the arithmetic means;
quantization means for quantizing output of the adding means and outputting a quantized value including the quantization error as a result of the ΔΣ modulation; and
subtracting means for calculating a difference between the output of the adding means and the quantized value of the output of the adding means to thereby calculate the quantization error,
the image processing method comprising the steps of:
the adding means adding up the pixel value of the image and the output of the arithmetic means;
the quantization means quantizing the output of the adding means and outputting the quantized value including the quantization error as the result of the ΔΣ modulation;
the subtracting means calculating the difference between the output of the adding means and the quantized value of the output of the adding means to thereby calculate the quantization error; and
the arithmetic means filtering the quantization error and outputting a result of the filtering to the adding means, wherein
a filter coefficient for the filtering by the arithmetic means corresponding to the analog output is determined according to a frequency characteristic of the analog conversion means.

9. A computer program for causing a computer to function as:
ΔΣ modulation means for applying ΔΣ modulation to an image to thereby convert gradation of the image; and
analog conversion means for converting a signal of the image, the gradation of which is converted by the ΔΣ modulation means, into an analog signal, wherein
the ΔΣ modulation means includes:
arithmetic means for filtering a quantization error;
adding means for adding up a pixel value of the image and output of the arithmetic means;
quantization means for quantizing output of the adding means and outputting a quantized value including the quantization error as a result of the ΔΣ modulation; and
subtracting means for calculating a difference between the output of the adding means and the quantized value of the output of the adding means to thereby calculate the quantization error, and
a filter coefficient for the filtering by the arithmetic means corresponding to the analog output is determined according to a frequency characteristic of the analog conversion means.

10. An image processing apparatus comprising:
a ΔΣ modulation unit configured to apply ΔΣ modulation to an image to thereby convert gradation of the image;
an analog conversion unit configured to convert a signal of the image, the gradation of which is converted by the ΔΣ modulation unit, into an analog signal;
a digital output unit configured to output a digital signal of the image after gradation conversion; and
an analog output unit configured to output an analog signal of the image after gradation conversion, wherein
the ΔΣ modulation unit includes
an arithmetic unit configured to filter a quantization error;
an adding unit configured to add up a pixel value of the image and output of the arithmetic unit;
a quantization unit configured to quantize output of the adding unit and output a quantized value including the quantization error as a result of the ΔΣ modulation; and
a subtracting unit configured to calculate a difference between the output of the adding unit and the quantized value of the output of the adding unit to thereby calculate the quantization error, and
a filter coefficient for the filtering by the arithmetic unit corresponding to the analog output is determined according to a frequency characteristic of the analog conversion unit.
